(19) United States
(12) Patent Application Publication
(10) Pub. No.: US 2016/0265559 A1
(43) Pub. Date: Sep. 15, 2016

(54) METERLESS HYDRAULIC SYSTEM HAVING IMPROVED FORCE MODULATION

(71) Applicant: Caterpillar Inc., Peoria, IL (US)

(72) Inventors: Jeremy PETERSON, Washington, IL (US); Jeffrey Lee Kuehn, Germantown Hills, IL (US); Michael Todd Verkuilen, Germantown Hills, IL (US)

(73) Assignee: Caterpillar Inc., Peoria, IL (US)

(21) Appl. No.: 14/642,676

(22) Filed: Mar. 9, 2015

(51) Int. Cl. F15B 11/028; E02F 9/22

(52) U.S. Cl. CPC F15B 11/028; E02F 9/2228; F15B 2211/55; F15B 2211/426; F15B 2211/6346

(57) ABSTRACT

A hydraulic system is disclosed. The hydraulic system may include an actuator configured to receive and discharge fluid via a first passage and a second passage, an input device configured to generate a signal indicative of a desire to operate the actuator, and pump configured to draw low-pressure fluid from one of the first and second passages and discharge fluid at an elevated pressure into the other of the first and second passages based on the signal from the input device. The hydraulic system may further include a charge circuit fluidly connected to the first and second passages, a force modulation control valve configured to selectively direct fluid from either of the first and second passages to the charge circuit based on the signal from the input device, and at least one relief valve configured to selectively direct fluid discharged from the pump to the charge circuit when the elevated pressure exceeds a pressure relief threshold.

### TECHNICAL FIELD

The present disclosure relates generally to a hydraulic system and, more particularly, to a meterless hydraulic system having improved force modulation.

### BACKGROUND

A conventional hydraulic system includes a pump that draws low-pressure fluid from a tank, pressurizes the fluid, and makes the pressurized fluid available to multiple different actuators for use in moving the actuators. In this arrangement, a speed and/or force of each actuator can be independently modulated by selectively throttling (i.e., restricting) a flow of the pressurized fluid from the pump into and/or out of each actuator. An alternative type of hydraulic system is known as a meterless hydraulic system, which generally includes a pump connected in closed-loop fashion to one or more actuators. During operation, the pump draws fluid from one chamber of the actuator(s) and discharges pressurized fluid to an opposing chamber of the same actuator(s). To move the actuator(s) at a higher or lower speed and/or force, the pump discharges fluid at a faster or slower rate. A meterless hydraulic system is generally more efficient than a conventional hydraulic system because the pump is controlled to only discharge as much fluid as is necessary to move the actuator(s) at a desired speed, and little or no throttling of the fluid flow is required, thereby reducing flow losses.

One problem with meterless hydraulic systems involves modulating the force output of the actuator(s). During force modulation, the output speed and/or force of the actuator(s) is limited, thereby allowing an operator to perform delicate positioning tasks. However, when actuator movement is suddenly halted (e.g., by an obstruction) or when more fluid is forced out of one side of the actuator than is being pumped into the other side (e.g., when a hydraulic cylinder is retracting), fluid pressure within a circuit can exceed a desired pressure for modulating force. When the desired pressure for force modulation is exceeded, force modulation becomes unavailable until the pressure in the circuit is returned to the desired pressure. Due to the closed loop configuration of meterless hydraulic systems, a significant delay may be experienced until the pressure is reduced.

An exemplary meterless hydraulic system is disclosed in US, Patent Publication 2014/0033698 of Opdenbosch that published on Feb. 6, 201.4 (the '698 publication). In the '698 publication, a closed-loop hydraulic system is described. The hydraulic system includes a pump that draws fluid from a first passage, pressurizes the fluid, and discharges the pressurized fluid into a second passage. The first and second passages are connected to opposite ends of an actuator having a head-end and a rod-end. Force modulation valves are actuated to direct fluid from the first and second passages into a charge circuit to limit fluid pressure in the passages. Makeup fluid is returned to the first and second passages from the charge circuit via a spring-biased, pilot-operated spool valve, or by one of two check valves, in order to accommodate excess fluid discharged during retraction of the actuator, two relief valves having fixed pressure limits may open to direct fluid into the charge circuit when their pressure limits are exceeded.

Although somewhat effective at modulating a force of the actuator, the hydraulic system of the '698 publication may not address certain aspects of force modulation when the actuator is suddenly brought to a stop or during cylinder retraction.

The hydraulic system of the present disclosure is directed toward solving one or more of the problems set forth above and/or other problems of the prior art.

### SUMMARY

In one aspect, the present disclosure is directed to a hydraulic system. The hydraulic system may include an actuator configured to receive and discharge fluid via a first passage and a second passage, an input device configured to generate a signal indicative of a desire to operate the actuator, and pump configured to draw low-pressure fluid from one of the first and second passages and discharge fluid at an elevated pressure into the other of the first and second passages based on the signal from the input device. The hydraulic system may further include a charge circuit fluidly connected to the first and second passages, a force modulation control valve configured to selectively direct fluid from either of the first and second passages to the charge circuit based on the signal from the input device, and at least one relief valve configured to selectively direct fluid discharged from the pump to the charge circuit when the elevated pressure exceeds a pressure relief threshold.

In another aspect, the present disclosure is directed to a method of operating a hydraulic system. The method may include receiving a signal indicative of a desire to move a work tool via an actuator, and drawing fluid from one of a first passage and a second passage fluidly connected to the actuator, pressurizing the fluid, and directing the pressurized fluid into the other of the first and second passages to move the actuator based on the signal. The method may further include selectively directing fluid from one of the first and second passages to a charge circuit to limit a force of the actuator based on the signal, and selectively directing fluid from one of the first and second passages to the charge circuit when the pressure of the fluid exceeds a pressure relief threshold based on the signal.

In yet another aspect, the present disclosure is directed to a machine. The machine may include a frame, a power source mounted to the frame, a work tool connected to the frame, and a hydraulic system driven by the power source and operatively connected to the work tool. The hydraulic system may include an actuator configured to receive and discharge fluid via a first passage and a second passage to move the work tool, an input device configured to generate a signal indicative of a desire to move work tool via the actuator, and a pump configured to draw low-pressure fluid from one of the first and second passages and discharge fluid at an elevated pressure into the other of the first and second passages based on the signal from the input device. The hydraulic system may further include a charge circuit fluidly connected to the first and second passages, a force modulation control valve configured to selectively direct fluid from either of the first and second passages to the charge circuit based on the signal from the input device, and at least one relief valve configured to selectively direct fluid discharged from the pump to the charge circuit when the elevated pressure exceeds a variable pressure relief threshold, the variable pressure relief threshold being adjustable based on the signal from the input device.

### BRIEF DESCRIPTION OF THE DRAWINGS

FIG. 1 is a pictorial illustration of an exemplary disclosed machine; and

FIG. 2 is a schematic illustration of an exemplary disclosed hydraulic system that may be used in conjunction with the machine of FIG. 1.

### DETAILED DESCRIPTION

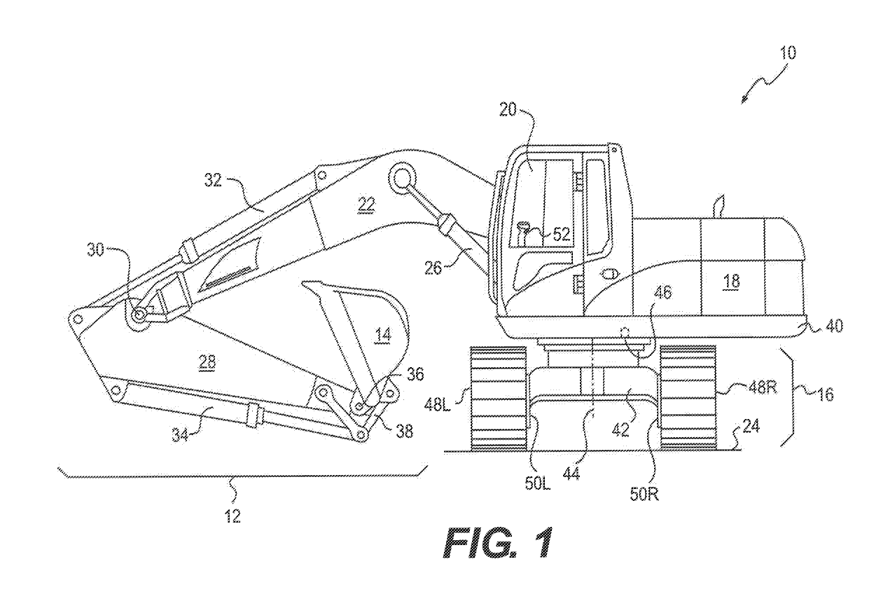

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be an earth moving machine such as the excavator shown in FIG. 1, a dozer, a loader, a backhoe, a motor grader, a dump truck, or any other earth moving machine, Machine 10 may include an implement system 12 configured to move a work tool 14, a drive system 16 for propelling machine 10, a power source 18 that provides power to implement system 12 and drive system 16, and an operator station 20 situated for manual control of implement system 12, drive system 16, and/or power source 18.

Implement system 12 may include a linkage structure acted on by fluid actuators to move work tool 14. In the disclosed exemplary embodiment, implement system 12 includes a boom 22 that is vertically pivotal about a horizontal axis (not shown) relative to a work surface 24 by a pair of adjacent, double-acting, hydraulic cylinders 26 (only one shown in FIG. 1). Implement system 12 also includes a stick 28 that is vertically pivotal about a horizontal axis 30 by a single, double-acting, hydraulic cylinder 32, and a single, double-acting, hydraulic cylinder 34 that is operatively connected between stick 28 and work tool 14 to pivot work tool 14 vertically about a horizontal pivot axis 36. Hydraulic cylinder 34 is connected to work tool 14 by way of a power link 38. Boom 22 is pivotally connected to a body 40 of machine 10, and body 40 is pivotally connected to an undercarriage 42 and movable about a vertical axis 44 by a hydraulic swing motor 46. Stick 28 is pivotally connect boom 22 to work tool 14 by way of axes 30 and 36. It is contemplated that implement system 12 may be arranged differently, if desired.

Numerous different work tools 14 may be attachable to a single machine 10 and operator controllable. Work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although connected in the embodiment of FIG. 1 to pivot in the vertical direction relative to body 40 of machine 10 and to swing in the horizontal direction, work tool 14 may alternatively or additionally rotate, slide, open and close, or move in any other manner known in the art.

Drive system 16 may include one or more traction devices powered to propel machine 10. In the disclosed example, drive system 16 includes a left track 48L located at one side of machine 10, and a right track 48R located at an opposing side of machine 10. Left track 48L may be driven by a left travel motor 50L, while right track 48R may be driven by a right travel motor 50R, It is contemplated that drive system 16 could alternatively include traction devices other than tracks, such as wheels, belts, or other known traction devices. Machine 10 may be steered by generating a speed and/or rotational direction difference between left and right travel motors 50L, 50R, while straight travel may be facilitated by generating substantially equal output speeds and rotational directions from left and right travel motors 50L, 50R.

Power source 18 may embody an engine such as, for example, a diesel engine, a gasoline engine, a gaseous fuel-powered engine, or any other type of combustion engine known in the art. It is contemplated that, in some applications, power source 18 may alternatively embody a non-combustion source of power such as a fuel cell, a power storage device, or another source known in the art, Power source 18 may produce a mechanical or electrical power output that may then be converted to hydraulic power for moving hydraulic cylinders 26, 32, 34, left and right travel motors 50L, 50R, and/or swing motor 46.

Operator station 20 may include devices that receive input from a machine operator indicative of desired machine maneuvering. Specifically, operator station 20 may include one or more input device(s) 52, for example a joystick, a steering wheel, and/or a pedal, that are located proximate an operator seat (not shown). Input device 52 may initiate movement of machine 10, for example travel and/or tool movement, by producing displacement signals that are indicative of desired machine maneuvering. Input device 52 may be movable from a minimum displacement position through a range to a maximum displacement position. Signals generated by input device 52 may correspond to movement parameters (e.g., speed, force, direction etc.) that vary over the range of displacement according to a linear, curvilinear, or other relationship. Accordingly, as an operator moves input device 52, the operator may affect a corresponding machine movement in a desired direction, with a desired speed, and/or with a desired force based on the amount displacement of input device 52.

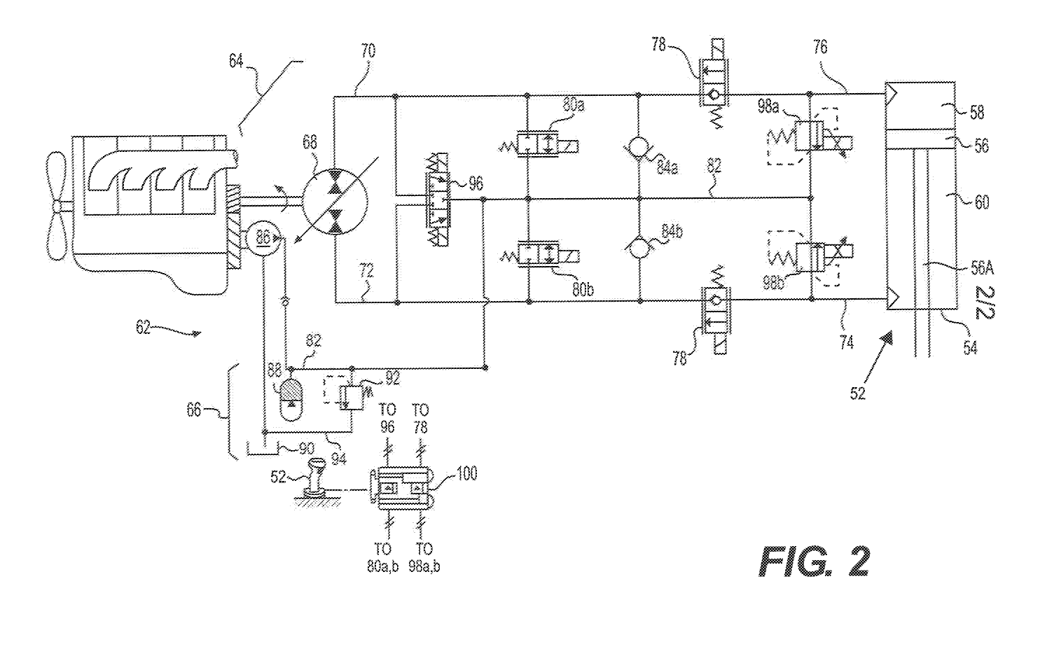

One exemplary linear actuator (one of hydraulic cylinders 26) is shown in the schematic of FIG. 2. It should be noted that, while a specific linear actuator is shown, the depicted actuator may represent any one or more of the linear actuators (e.g., hydraulic cylinders 26, 32, 34) or the rotary actuators (left travel, right travel, or swing motors 50L, 50R, 46) of machine 10.

As shown schematically in FIG. 2, hydraulic cylinder 26 may comprise any type of linear actuator known in the art. Hydraulic cylinder 26 may include a tube 54, and a piston assembly 56 arranged within tube 54 to form a first chamber 58 and an opposing second chamber 60. In one example, a rod portion 50A of piston assembly 56 may extend through an end of second chamber 60. As such, second chamber 60 may be considered the rod-end chamber of hydraulic cylinders 26 and 34, while first chamber 58 may be considered the head-end chamber.

First and second chambers 58, 60 may each be selectively provided with pressurized fluid and drained of the pressurized fluid to cause piston assembly 56 to move within tube 54, thereby changing an effective length of hydraulic cylinder 26 and moving work tool 14 (referring to FIG. 1). A flow rate of fluid into and out of first and second chambers 58, 60 may relate to a translational velocity of hydraulic cylinder 26, while a pressure differential between first and second chambers 58, 60 may relate to a force imparted by hydraulic cylinder 26 on the associated linkage structure of implement system 12. It should be noted that, although hydraulic cylinders 32 and 34 are not shown in FIG. 2, their structure and operation may be similar that described above with respect to hydraulic cylinder 26.

Left travel, right travel, and swing motors 50L, 50R, 46 (referring to FIG. 1), like hydraulic cylinder 26, may be driven by a fluid pressure differential, Specifically, each of these motors may include first and second chambers (not shown) located to either side of a pumping mechanism, such as an impeller, plunger, or series of pistons (not shown). When the first chamber is filled with pressurized fluid and the second chamber is drained of fluid, the pumping mechanism may be urged to move or rotate in a first direction, Conversely, when the first chamber is drained of fluid and the second chamber is filled with pressurized fluid, the pumping mechanism may be urged to move or rotate in an opposite direction. The flow rate of fluid into and out of the first and second chambers may determine a rotational velocity of the corresponding motor, while a pressure differential across the pumping mechanism may determine an output torque. It is contemplated that a displacement of left travel motor 50L, right travel motor 50R, and/or swing motor 46 may be variable, if desired, such that for a given flow rate and/or pressure of supplied fluid, a rotational speed and/or output torque of the motor may be adjusted.

As illustrated in FIG. 2, machine 10 may include a hydraulic system 62 having a plurality of fluid components that cooperate to move work tool 14 and machine 10 via hydraulic cylinder 26. In particular, hydraulic system 62 may include, among other things, a tool circuit 64 and a charge circuit 66. Tool circuit 64 may be a boom circuit associated with hydraulic cylinder 26. Charge circuit 66 may be selectively fluidly connected with tool circuit 64 to receive excess fluid from tool circuit 64 and/or to provide makeup fluid to tool circuit 64, as necessary. It is contemplated that additional and/or different configurations of circuits may be included within hydraulic system 62 such as, for example, a bucket (not shown) circuit associated with hydraulic cylinder 34 and swing motor 46; a stick circuit (not shown) associated with hydraulic cylinder 32, left travel motor 50L, and right travel motor 50R; or an independent circuit associated with each separate actuator (e.g., with each of hydraulic cylinders 32, 34, 26; left travel motor 50L; right travel motor 50R; and/or swing motor 46), if desired. In addition, in exemplary embodiments, one or more of the circuits of hydraulic system 62 may be meterless circuits.

In the disclosed embodiment, tool circuit 64 includes a plurality of interconnecting and cooperating fluid components that facilitate independent use and control of hydraulic cylinder 26. For example, tool circuit 64 may include a pump 68 that is fluidly connected to hydraulic cylinder 26 via a closed-loop formed by a first pump passage 70, a second pump passage 72, a rod-end passage 74, and a head-end passage 76. To cause hydraulic cylinder 26 to extend, head-end passage 76 may be filled with fluid pressurized by pump 68 (via first or second pump passages 70, 72, depending on a rotational direction of pump 68), while rod-end passage 74 may be filled with fluid returning from hydraulic cylinder 26 (via the other first or second pump passages 70, 72). In contrast, during a retracting operation, rod-end passage 74 may be filled with fluid pressurized by pump 68, while head-end passage 76 may be filled with fluid returning from hydraulic cylinder 26. First and second pump passages may be fluidly connected to exchange fluid (e.g., excess fluid and/or makeup fluid) with charge circuit 66 during extending and retraction operations of cylinder 26.

Pump 68 may be a variable displacement, overcenter-type pump. That is, pump 68 may be controlled to draw fluid (e.g., low-pressure fluid) from hydraulic cylinder 26 via one of first and second pump passages 70 and discharge the fluid at a specified elevated pressure through a range of flow rates back to hydraulic cylinder 26 via the other of first and second pump passages 70, 72, For this purpose, pump 68 may include a displacement controller, such as a swashplate and/or other like stroke-adjusting mechanism. The position of various components of the displacement controller may be electro-hydraulically and/or hydro-mechanically adjusted based on, among other things, a demand, a desired speed, a desired torque, and/or a load of hydraulic cylinder 26 to thereby change a displacement (e.g., a discharge rate and/or pressure) of pump 68. The displacement of pump 68 may be varied from a zero displacement position at which substantially no fluid is discharged from pump 68, to a maximum displacement position in a first direction at which fluid is discharged from pump 68 at a maximum rate and/or pressure into first pump passage 70, 72, Likewise, the displacement of pump 68 may be varied from the zero displacement position to a maximum displacement position in a second direction at which fluid is discharged from pump 68 at a maximum rate and/or pressure into second pump passage 72. Pump 68 may be drivably connected to power source 18 of machine 10 by, for example, a countershaft, a belt, or in another suitable manner. Alternatively, pump 68 may be indirectly connected to power source 18 via a torque converter, a gear box, an electrical circuit, or in any other manner known in the art. It is contemplated that pump 68 may alternatively be a non-overcenter (i.e., unidirectional) pump, if desired.

Pump 68 may also be selectively operated as a motor. More specifically, when hydraulic cylinder 26 is operating in an overrunning condition, the fluid discharged from hydraulic cylinder 26 may have a pressure elevated higher than an output pressure of pump 68. In this situation, the elevated pressure of the actuator fluid directed back through pump 68 may function to drive pump 68 to rotate with or without assistance from power source 18. Under some circumstances, pump 68 may even be capable of imparting energy to power source 18, thereby improving an efficiency and/or capacity of power source 18.

Hydraulic system 62 may be provided with one or more load-holding valves 78 that are configured to maintain a position of hydraulic cylinder 26 when no movement thereof has been requested, Such load-holding valves 78 may embody, for example, two-position, two-way, solenoid-controlled valves. Each load-holding valve 78 may be moveable from a first position at which fluid may freely flow in either direction between the corresponding first or second pump passage 70, 72 and the corresponding rod- or head-end passage 74, 76, to a second position (shown in FIG. 2) at which fluid may flow only in one direction into the rod- or head-end passage 74, 76 based on a pressure differential across load-holding valve 78. Load-holding valves 78 may be spring-biased to their second positions (i.e., load-holding valves 78 may normally be in the second positions). When loading holding valves 78 are in their second positions, fluid may be inhibited from leaving hydraulic cylinder 26 through load-holding valves 78, thereby locking hydraulic cylinder 26 in a particular actuated position.

It will be appreciated by those of skill in the art that the respective rates of fluid flow into and out of first and second chambers 58, 60 of hydraulic cylinder 26 during extension and retraction may not be equal. That is, because of the location of rod portion 56A within second chamber 60, piston assembly 56 may have a reduced pressure area within second chamber 60, as compared with a pressure area within first chamber 58. Accordingly, during retraction of hydraulic cylinder 26, more fluid may be forced out of first chamber 58 than can be consumed by second chamber 60 and, during extension, more fluid may be consumed by first chamber 58 than is forced out of second chamber 60. When more fluid is forced out of first chamber 58 than is consumed by second chamber 60, some of the excess fluid may be pumped from first pump passage 70 into second pump passage 72. However, the amount of excess fluid pumped into second passage 72 may, at times, be too great for other components of tool circuit 64 to handle without resulting in a pressure increase.

In order to accommodate the excess fluid discharged during retraction of hydraulic cylinder 26 and prevent a loss of force modulation control, tool circuit 64 may be provided with two bypass valves 80a, 80b that are fluidly coupled with charge circuit 66 via a common passage 82, Bypass valves 80a, 80b may be provided to selectively allow fluid to be relieved from hydraulic cylinder 26 and directed through first or second passage 70, 72 into charge circuit 66 to maintain the pressure of the fluid in first and/or second passages 70, 72 at or below a desired pressure limit. In one embodiment, bypass valves 80a, 80b may be solenoid-operated and configured to open when cylinder 26 is being retracted. For example, bypass valves 80a, 80b may be opened based on the displacement of input device 52, the position of piston assembly 56, and/or a fluid pressure in first or second pump passage 70, 72. Bypass valves 80a, 80b may be spring-biased to return to a closed position. Bypass valves 80a, 80b may be actuated in different ways and by different methods, if desired.

In order to accommodate the additional fluid required during extension of hydraulic cylinder 26, tool circuit 64 may be provided with two makeup valves 84a, 84b that are fluidly coupled with charge circuit 66 via common passage 82. Makeup valves 84a, 84b may each be check valves or another type of valve (e.g., solenoid-operated valves) fluidly coupled between first and second pump passages 70, 72 and common passage 82, at a location between pump 68 and load-holding valves 78. In this position, makeup valves 84a, 84b may be configured to block flow in a first direction and to permit flow only in a second direction. For example, makeup valves 84a, 84b may be configured to selectively allow pressurized fluid from charge circuit 66 to enter first and/or second pump passages 70, 72, Such valves may, however, prohibit fluid from passing in the opposite direction.

Charge circuit 66 may include at least one hydraulic source fluidly connected to common passage 82 described above. In the disclosed embodiment, charge circuit 66 has two sources, including a charge pump 86 and an accumulator 88, which are fluidly connected to common passage 82 in parallel to provide makeup fluid to tool circuit 64. Charge pump 86 may embody, for example, an engine-driven, fixed or variable displacement pump configured to draw fluid from a tank 90, pressurize the fluid, and discharge the fluid into common passage 82. Accumulator 88 may embody, for example, a compressed gas, membrane/spring, or bladder type of accumulator configured to accumulate pressurized fluid from and discharge pressurized fluid into common passage 82. Excess hydraulic fluid, either from charge pump 86 or from tool circuit 64 (i.e., from operation of pump 68 and/or hydraulic cylinder 26) may be directed into either accumulator 88, or into tank 90 by way of a charge relief valve 92 disposed in a return passage 94. Charge relief valve 92 may be movable from a flow-blocking position toward a flow-passing position as a result of elevated fluid pressures within common passage 82 and return passage 94.

One or more force modulation control valve(s) 96 may be associated with tool circuit 64 (e.g., associated with one or both of first and second pump passages 70, 72) to help regulate a speed and/or force of work tool 14 imparted by hydraulic cylinder 26. It is contemplated, however, that force modulation control valve 96 could alternatively or additionally be associated with other hydraulic actuators (e.g., hydraulic cylinder 32, hydraulic cylinder 34, swing motor 46, left and/or right travel motors 50L, 50R) and/or other circuits of hydraulic system 62, if desired.

Force modulation control valve 96 may be disposed between first and second pump passages 70, 72 and common passage 82, and selectively movable by solenoid force against a spring bias between a first position and a second or third position. When force modulation control valve 96 is in the first position (shown in FIG. 2), fluid flow through force modulation control valve 96 may be inhibited. It should be noted that, when force modulation control valve 96 is in the first position, flow through force modulation control valve 96 may either be completely blocked (shown in FIG. 2) or only restricted to inhibit flow by a desired amount. That is, force modulation control valve 96 may embody a spool valve, and when force modulation control valve 96 is in the first position, passages within force modulation control valve 96 may only be partially blocked by lands of the spool valve, thereby permitting limited flow. Accordingly, any reference to the first position of force modulation control valve 96 as being a flow-inhibiting position is intended to include both a completely blocked condition and a condition wherein flow through force modulation control valve 96 is limited but still possible. It is noted, however, that in other embodiments, force modulation control valve may alternatively be fully opened (i.e., unrestricted) in the first position.

Force modulation control valve 96 may be configured to selectively direct fluid discharged from pump 68 to charge circuit 66 via common passage 82 to limit the fluid pressure elevated by pump 68 based on a desired pressure limit. When force modulation control valve 96 is moved between the first position and either the second or third position, force modulation control valve 96 may direct fluid from first or second pump passages 70,72 into charge circuit 66 via common passage 82, thereby reducing the flow rate and/or pressure of fluid passing though first and/or second pump passages 70, 72.

For example, when force modulation control valve 96 is in the second position, force modulation control valve 96 may function as a bypass valve to selectively allow fluid pressurized by pump 68 to bypass hydraulic cylinder 26 and flow from first pump passage 70 into common passage 82 and either into charge circuit 66 or into the inlet of pump 68 via makeup valves 84a, 84b, depending on a pressure differential. Force modulation control valve 96 may be movable to any position between the first and second positions. And, depending on the position of force modulation control valve 96, a different flow rate and/or pressure of fluid may bypass hydraulic actuator 26, thereby changing the flow rate and/or pressure of fluid within first pump passage 70.

When force modulation control valve 96 is in the third position, force modulation control valve 96 may function as a bypass valve to selectively allow fluid pressurized by pump 68 to bypass hydraulic cylinder 26 and flow from second pump passage 72 into common passage 82 and either into charge circuit 66 or into the inlet of pump 68 via makeup valves 84a, 84b, depending on a pressure differential. Force modulation control valve 96 may be movable to any position between the first and third positions. And, depending on the position of force modulation control valve 96, a different flow rate and/or pressure of fluid may bypass hydraulic actuator 26, thereby changing the flow rate and/or pressure of fluid within second pump passage 72.

When high-pressure fluid from either of first or second pump passages 70, 72 bypasses hydraulic cylinder 26 via force modulation control valve 96 and flows into charge circuit 66 (or directly into the other of first and second pump passages 70, 72), a reduction in speed and/or force of hydraulic cylinder 26 may occur. In particular, because there may be little resistance to the flow of fluid bypassing hydraulic cylinder 26 when force modulation control valve 96 is away from its first position, the pressure of the fluid within tool circuit 64 may be limited and remain relatively low. This low-pressure may result in a reduced speed and/or three capacity of hydraulic cylinder 26 and a corresponding increase in controllability over the movement of work tool 14. As force modulation control valve 96 nears its first position, a greater resistance may be placed on the flow of bypassing fluid within tool circuit 64, thereby causing a corresponding rise in the pressure of all fluid within tool circuit 64 and in the resulting speed and/or force capacity of hydraulic cylinder 26.

Accordingly, as an operator of machine 10 displaces input device 52, force modulation control valve 96 may limit the fluid pressure within first or second pump passage 70, 72 based on a desired pressure limit that is based on the signal generated by input device 52. For example, smaller displacements of input device 52 (e.g., when a command for the output force of cylinder 26 is lowered) may generate signals to displace a spool within force modulation control valve 96 a greater distance from the first position toward the second or third position (i.e., to move farther away from the first position), which correspond to lower desired pressure limits and lower force limits on cylinder 26. That is, force modulation control valve 96 may be configured to move to a more flow-passing position when input device 52 is moved to a position of less displacement.

Conversely, large displacements of input device 52 (e.g., when a command for the output force of cylinder 26 is raised) may generate signals to displace the spool within force modulation control valve 96 a smaller distance from the first position (Le, to move closer to the first position), which corresponds to higher pressure limits and imposes higher force limits on cylinder 26. In other words, as the operator requests a greater force from hydraulic cylinder 26 (e.g., as the operator displaces input device 52 by a greater distance), the spool within force modulation control valve 96 may be caused to move closer to its first position. That is, force modulation control valve 96 may be configured to move to a less flow-passing position when input device 52 is moved to a position of greater displacement. When force modulation control valve 96 is moved fully to the first position (e.g., when an operator requests maximum force), substantially no fluid may be bypassing hydraulic cylinder 26 via force modulation control valve 96, such that full speed and/or force of hydraulic cylinder 26 may be available to the operator.

In other embodiments, force modulation control valve 96 may be fully open its first position instead of fully closed. In such embodiments, when force modulation control valve is fully open in its first position, smaller displacements of input device 52 may cause force modulation valve 96 to move smaller distances from its first position, which correspond to lower desired pressure and force limits. In contrast, larger displacements of input device 52 may cause force modulation control valve to move greater distances from its first position to less flow-passing positions, which correspond to higher desired pressure and force limits.

It should be noted that in the disclosed embodiment when force modulation control valve 96 is fully in the first position, force modulation control valve 96 may no longer be restricting the flow of any fluid through tool circuit 64. Accordingly, any metering losses associated with force modulation control valve 96 may only be experienced when force modulation control valve 96 is metering (i.e., in a position other than the first position). The functionality provided by force modulation control valve 96 may result in greater control over hydraulic cylinder 26 and allow hydraulic cylinder 26 to stop when a load on work tool 14 increases beyond a particular level, thereby enabling the operator to accomplish delicate position control tasks. Although force modulation control valve 96 is shown as a three-position, solenoid-operated, spool-type valve, it is contemplated that force modulation control valve 96 could have another form, if desired.

In some embodiments, force modulation control valve 96 may be configured to reach its first position before input device 52 is fully displaced, That is, fluid pressure and the three of cylinder 26 may only be limited over a certain range of displacement of input device 52. For example, force modulation control valve 96 may reach its first position after input device 52 is displaced to a certain position between a maximum displacement position and a minimum displacement position. In some embodiments, the displacement position of input device 52 may be determined as an angle of displacement or as a certain percentage of a full displacement. In this way, a maximum speed and/or force of cylinder 26 may be available to the operator for use while performing tasks.

Hydraulic system 62 may further include two pressure relief valves 98a, 98b fluidly connected between first and second pump passages 70, 72 and common passage 82 to relieve first and second pump passages 70, 72 from sudden pressure increases that can temporarily inhibit three modulation control, Pressure relief valves 98a, 98b may be configured to selectively divert fluid discharged from pump 68 to charge circuit 66 when the fluid pressure elevated by pump 68 exceeds a pressure relief threshold. For example, when cylinder 26 suddenly encounters a physical obstruction, the fluid pressure within first and/or second pump passages 70, 72 may suddenly rise beyond the pressure limit set by force modulation control valve 96 before the output of pump 68 is reduced (e.g., before pump 68 can be de-stroked), thereby causing a temporary loss of force modulation control. When the fluid pressure within first and/or second pump passage 70, 72 exceeds the pressure relief threshold, pressure relief valves 98a, 98b may open and divert excess fluid to charge circuit 66 via common passage 82 in order to reduce the pressure within pump passages 70, 72 and restore force modulation control.

To reduce the time taken to regain force modulation control, the pressure relief threshold of pressure relief valves 98a, 98b may be set near the pressure limit of force modulation control valve 96. In this way, fluid pressure within first and/or second pump passages may be prevented from reaching high pressures that require more time to reduce. To achieve this function, pressure relief valves 98a, 98b may be variable-pressure relief valves having variable pressure relief thresholds that may be adjusted in coordination with the desired pressure limit set by force modulation control valve 96, For example, pressure relief valves 98a, 98b may be pilot-operated and spring-biased relief valves having solenoid-adjustable pressure relief thresholds.

The pressure relief threshold of valves 98a, 98b may be varied based on the signal from input device 52 and varied in coordination with the desired pressure limit of force modulation control valve 96. For example, when the operator displaces input device 52, the pressure relief threshold of valves 98a, 98b may be varied (e.g., by an associated solenoid) to be greater when input device 52 is moved to a position of greater displacement, or to be less when input device 52 is moved to a position of less displacement. In one embodiment, the change in the pressure relief threshold with respect to the displacement of input device 52 may be directly proportional to the change in the pressure limit set by force modulation control valve 96 with respect to the displacement of input device 52. In other embodiments, the pressure relief threshold of valves 98a, 98b may be adjusted with respect to the displacement of input device 52 and the pressure limit set by force modulation control valve 96 according to a map, model, algorithm, or other relationship.

The pressure relief threshold of valves 98a, 98b may be adjusted to optimally reduce the time taken to return the pressure in first and/or second pump passages 70, 72 to the pressure limit set by force modulation control valve 96. For example, the pressure relief threshold may be adjusted to be higher than the pressure limit set by force modulation control valve 96 by a desired amount, such as by about 1-5 MPa (e.g., 2-3 MPa). Alternatively, the pressure relief threshold may be adjusted to be higher than the pressure limit set by force modulation control valve 96 by an amount based on the signal generated by input device 52, the fluid pressure within first and/or second pump passages 70, 72, and/or any other parameter or relationship. To prevent damage to components of hydraulic system 62, pressure relief valves 98a, 98b may also be configured to open when the fluid pressure exceeds a maximum pressure threshold whether or not the pressure relief threshold has been reached.

Pressure relief valves 98a, 98b may function independently of bypass valves 80a, 80b in order to allow sudden pressure increases to be relieved at any time during actuation of cylinder 26. For example, pressure relief valves 98a, 98b may not be relied on to direct fluid into charge circuit 66 from first and/or second pump passages 70, 72 during retraction of cylinder 26 unless the fluid pressure therein exceeds the pressure relief threshold. In this way, bypass valves 80a, 80b may be optimally controlled to remove excess fluid during retraction of cylinder, and pressure relief valves 96a, 98b may constantly remain available to effectively reduce sudden pressure increases as soon as the pressure relief threshold is reached.

Due to the inclusion of pressure relief valves 98a, 98b and bypass valves 80a, 80b to for accommodating excess fluid and high pressure surges in tool circuit 64, the size and flow capacity of force modulation control valve 96 may be reduced, Because force modulation control valve need not be used to direct fluid into charge circuit 66 during retraction of cylinder 26 or during high pressure surges, the size of force modulation control valve and its internal passages may be reduced, thereby reducing flow losses that occur when force modulation control valve is between its first and second or third position. Accordingly, the sizes and capacities of bypass valves 80a, 80b and pressure relief valves 98a, 98b may be optimized to relieve tool circuit 64 of excess fluid and high pressure surges. In this way, force modulation control valve 96 may be allowed to control the fluid pressure within first or second pump passage 70, 72 during retraction of cylinder 26 without interruption, with less delay after high pressure surges, and with greater efficiency.

During operation of machine 10, the signals generated by input device 52 may be provided to a controller 100. Signals generated by the operator via input device 52 may identify desired movements of other various linear and/or rotary actuators of machine 10 in addition to those of cylinder 26. Based upon one or more signals, including the signal from input device 52 and, for example, signals from various pressure sensors and/or position sensors (not shown) located throughout hydraulic system 62, controller 100 may command movement of the different valves and/or displacement changes of the different pumps and motors to advance a particular one or more of the linear and/or rotary actuators to a desired position in a desired manner (i.e., at a desired speed and/or with a desired force).

Controller 100 may embody a single microprocessor or multiple microprocessors that include components for controlling operations of hydraulic system 62 based on input from an operator of machine 10 and based on sensed or other known operational parameters. Numerous commercially available microprocessors can be configured to perform the functions of controller 100. It should be appreciated that controller 100 could readily be embodied in a general machine microprocessor capable of controlling numerous machine functions. Controller 100 may include a memory, a secondary storage device, a processor, and any other components for running an application. Various other circuits may be associated with controller 100 such as power supply circuitry, signal conditioning circuitry, solenoid driver circuitry, and other types of circuitry.

### INDUSTRIAL APPLICABILITY

The disclosed hydraulic system may be applicable to any machine where improved hydraulic efficiency and control is desired. The disclosed hydraulic system may provide for improved efficiency through the use of meterless technology and force modulation. Particularly, the disclosed hydraulic system may provide for improved force modulation using bypass valves 80a, 80b and variable pressure relief valves 98a, 98b to assist force modulation control valve 96 in limiting the fluid pressure within pump passages 70, 72 during operation of hydraulic system 62. Operation of hydraulic system 62 will now be described.

During operation of machine 10, an operator located within station 20 may displace input device 52 in a particular direction by a particular amount and/or with a particular speed to command motion of work tool 14 in a desired direction, at a desired velocity, and/or with a desired force, One or more corresponding signals generated by input device 52 may be provided to controller 100 indicative of the desired motion, along with machine performance information, for example sensor data such a pressure data, position data, speed data, pump or motor displacement data, and other data known in the art.

For example, in response to the signals from input device 52 indicative of a desire to lift work tool 14 with an increasing velocity, and based on the machine performance information, controller 100 may generate control signals directed to the stroke-adjusting mechanism of pump 68 within tool circuit 64 and/or to force modulation control valve 96. These control signals may include a first control signal that causes pump 68 to increase its displacement and discharge pressurized fluid into first pump passage 70 at a greater rate. When fluid from pump 68 is directed into first chamber 58 via first pump passage 70 and head-end passage 76, return fluid from second chamber 60 of hydraulic cylinders 26 may flow back to pump 68 via rod-end passage 74 and second pump passages 72 in closed-loop manner. At this time, the pressure of fluid within first pump passage 70 may be greater than the pressure of fluid within second pump passage 72. At this time, makeup fluid may be directed from charge circuit 66 into tool circuit 64 via common passage 82 and makeup valve 84b.

At about this same time, a control signal may be sent to force modulation control valve 96, causing force modulation control valve 96 to move to a position corresponding to the displacement of input device 52. For example, if input device 52 is displaced by only a small amount (i.e. directing more fluid to charge circuit 66), force modulation control valve 96 may be moved nearly or all the way to one of its flow-passing positions, at which a large amount of fluid from first pump passage 70 may bypass hydraulic cylinder 26 and flow into charge circuit 66 via common passage 82 and/or directly into second pump passage 72 via makeup valve 84b, depending on the pressure. In this situation, hydraulic cylinder 26 may be extending relatively slowly and/or with relatively little force. The extension may continue until work tool 14 becomes more heavily loaded or engages an immovable mass, at which time work tool 14 may stop moving and all of the fluid from first pump passage 70 may be forced to bypass hydraulic cylinder 26 and flow into charge circuit 66 via common passage 82.

However, when input device 52 is displaced by a greater amount (e.g., moved further after work tool has been stopped), force modulation control valve 96 may be caused by controller 100 to move a greater amount towards its flow-blocking position, at which a lesser amount of fluid from first pump passage 70 may bypass hydraulic cylinder 26 and flow into charge circuit 66 via common passage 82. In this situation, hydraulic cylinder 26 may extend more quickly and/or with greater force, as more fluid will be directed into hydraulic cylinders 26. As the operator continues to displace input device 52 by greater amounts, force modulation control valve 96 may eventually move all the way to its flow-blocking position (i.e. directing less fluid to charge circuit 66), and hydraulic cylinder 26 will move with a maximum force and/or at a maximum speed. In this manner, the operator may be provided with force control over hydraulic cylinders 26. Force modulation of other actuators within hydraulic system 62 may be regulated in a similar manner.

To drive hydraulic cylinder 26 at an increasing speed in a retracting direction (e.g., to lower work tool 14), controller 100 may generate a first control signal that causes pump 68 of tool circuit 64 to increase its displacement in a reverse flow direction and discharge pressurized fluid into second pump passage 72 at a greater rate, while simultaneously generating a second control signal that causes force modulation control valve 96 to move to a position corresponding to the displacement of input device 52. When input device 52 is displaced by only a small amount, force modulation control valve 96 may move nearly or all the way to its flow-passing position and, when input device 52 is displaced by a greater amount, force modulation control valve 96 may move towards its flow-blocking position. The high-flow second position may result in a relatively lower extending speed and/or force of hydraulic cylinder 26, as compared with the more restricted first position. As described above, when fluid from pump 68 is directed into second chamber 60 of hydraulic cylinder 26, return fluid from first chamber 58 may flow back into pump 68 in closed-loop manner, thereby allowing hydraulic cylinder 26 to retract at a speed and/or at a force related to the displacement of pump 68 and the position of force modulation control valve 96.

At about this same time, a greater amount of fluid may be exiting first chamber 58 than is entering second chamber 60 due to a volume of second chamber 60 being displaced by rod portion 56A. Controller 100 may then generate a signal to open bypass valve 80a to direct fluid from first pump passage 70 into charge circuit 66 via common passage 82. In this way, excess fluid may be directed into charge circuit 66 instead of being forced through pump 68, which could otherwise increase the fluid pressure within first and second pump passages 70, 72. Bypassing excess fluid via valve 80a into charge circuit 66 may limit the fluid pressure within tool circuit 64 and allow force modulation control valve 96 to continue to control the pressure within tool circuit 64 based on the signal generated by input device 52.

During extension or retraction of cylinder 26, the fluid pressure within tool circuit 64 may suddenly increase above the pressure limit set by force modulation control valve 96 when the movement of cylinder 26 is impeded by an external force. When work tool 14 encounters an immovable object and its travel is stopped, pump 68 may continue to pump fluid from one side of cylinder 26 to the other, thereby increasing the pressure within tool circuit 64 until pump 68 is de-stroked. Such a pressure increase may be known as a transient event. When the increased pressure surpasses the pressure limit set by force modulation control valve 96, force modulation control may be temporarily disabled until the pressure is reduced, Thus, controller 100 may generate a signal to adjust the stroke adjusting mechanism of pump 68 to reduce the displacement of pump 68.

When the pressure within first or second pump passage 70, 72 exceeds a pressure relief threshold before pump 68 is de-stroked, pressure relief valves 98a, 98b may be forced open against an adjustable spring force to direct fluid from first and/or second pump passages 70, 72 into charge circuit to more quickly relieve the pressure in tool circuit 64. Controller 100 may adjust the pressure relief threshold of valves 98a, 98b via an associated solenoid in coordination with the pressure limit set by force modulation control valve 96 and based on the signal generated by the operator via input device 52. In this way, the pressure relief threshold may rise and fall with the pressure limit set by force modulation control valve 96, thereby allowing pressure relief valves 98a, 98b to open soon after the pressure within tool circuit 64 has exceeded the limit set by force modulation control valve. When pressure relief valves 98a, 98b are open and fluid from tool circuit 64 is directed into charge circuit 66, the fluid pressure within tool circuit 64 may be quickly reduced and force modulation control valve 96 may resume control of the pressure within tool circuit 64.

In the disclosed hydraulic system, flows provided by pump 68 may be substantially unrestricted during modulation of hydraulic cylinder 26, such that significant energy is not unnecessarily wasted in the actuation process. Thus, embodiments of the disclosure may provide improved energy usage and conservation. In addition, the closed-loop operation of hydraulic system 62 may, in some applications, allow for a reduction or even complete elimination of metering valves for controlling fluid flow associated with the linear and rotary actuators. This reduction may result in a less complicated and/or less expensive system.

The disclosed hydraulic system may also provide for improved force modulation of hydraulic cylinder 26, In particular, through pressure control facilitated by force modulation control valve 96, an operator of machine 10 may be provided greater control of the speed and/or force of work tool 14. This control may be improved by the use of bypass valves 80a, 80b and variable pressure relief valves 98a, 98b that help maintain the fluid pressure within tool circuit 64 at or near the pressure set by force modulation control valve 96 during cylinder retraction and transient events. This improved control may provide for enhanced performance of machine 10.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
an actuator configured to receive and discharge fluid via a first passage and a second passage;
an input device configured to generate a signal indicative of a desire to operate the actuator;
a pump configured to draw low-pressure fluid from one of the first and second passages and discharge fluid at an elevated pressure into the other of the first and second passages based on the signal from the input device;
a charge circuit fluidly connected to the first and second passages;
a force modulation control valve configured to selectively direct, fluid from either of the first and second passages to the charge circuit based on the signal from the input device; and
at least one relief valve configured to selectively direct fluid discharged from the pump to the charge circuit when the elevated pressure exceeds a pressure relief threshold.

2. The hydraulic system of claim 1, wherein the pressure relief threshold is variable and set based on the signal from the input device.

3. The hydraulic system of claim 2, wherein:
the signal from the input device is indicative of a displacement position of the input device; and
the pressure relief threshold is adjusted to be greater when the input device is moved to a position of greater displacement.

4. The hydraulic system of claim 3, wherein the pressure relief threshold is adjusted to be less when the input device is moved to a position of less displacement.

5. The hydraulic system of claim 4, wherein the at least one relief valve includes:
a first relief valve configured to selectively direct fluid from the first passage to the charge circuit when a fluid pressure in the first passage exceeds the pressure relief threshold; and
a second relief valve configured to selectively direct fluid from the second passage to the charge circuit when a fluid pressure in the second passage exceeds the pressure relief threshold.

6. The hydraulic system of claim 1, wherein the force modulation control valve is movable based on the signal from the input device between a first position at which flow through the force modulation control valve is prohibited and a second position at which flow is allowed to pass between the first passage and the charge circuit.

7. The hydraulic system of claim 6, wherein the force modulation control valve is movable based on the signal from the input device between the first position and a third position at Which flow is allowed to pass between the second passage and the charge circuit.

8. The hydraulic system of claim 7, wherein:
the signal from the input device is indicative of a displacement position of the input device; and
the force modulation control valve is configured to pass a greater amount of fluid when the input device is moved to a position of less displacement.

9. The hydraulic system of claim 8, wherein the force modulation control valve is configured to pass a lesser amount of fluid when the input device is moved to a position of greater displacement.

10. The hydraulic system of claim 7, wherein the force modulation control valve is configured to pass more fluid when a command for an output force of the actuator is lowered.

11. The hydraulic system of claim 10, wherein the force modulation control valve is configured to pass less fluid when the command for an output force of the actuator is raised.

12. A method of operating a hydraulic system, comprising:
receiving a signal indicative of a desire to move a work tool via an actuator;
drawing fluid from one of a first passage and a second passage fluidly connected to the actuator, pressurizing the fluid, and directing the pressurized fluid into the other of the first and second passages to move the actuator based on the signal;
selectively directing fluid from one of the first and second passages to a charge circuit to limit a force of the actuator based on the signal; and
selectively directing fluid from one of the first and second passages to the charge circuit when a pressure of the fluid exceeds a pressure relief threshold based on the signal.

13. The method of claim 12, further including varying the pressure relief threshold based on the signal.

14. The method of claim 13, wherein:
the signal is indicative of a displacement of an input device; and
the method further includes adjusting the pressure relief threshold to be greater when the input device is moved to a position of greater displacement.

15. The method of claim 14, further including adjusting the pressure relief threshold to be less when the input device is moved to a position of less displacement.

16. The method of claim 12, wherein selectively directing fluid from one of the first and second passages to the charge circuit to limit the force of the actuator includes moving a valve between a first position at which flow into the charge circuit is prohibited and a second position at which flow is allowed to pass between the first passage and the charge circuit.

17. The method of claim 16, wherein selectively directing fluid from one of the first and second passages to the charge circuit to limit the force of the actuator includes moving the valve between the first position a second position at which flow is allowed to pass between the second passage and the charge circuit.

18. The method of claim 17, further including directing more fluid from one of the first and second passages to the charge circuit based on the signal to limit the force of the actuator more.

19. The method of claim 18, further including directing less fluid from one of the first and second passages to the charge circuit based on the signal to limit the force of the actuator less.

20. A machine, comprising:
a frame;
a power source mounted to the frame;
a work tool connected to the frame; and
a hydraulic system driven by the power source and operatively connected to the work tool, the hydraulic system including:
an actuator configured to receive and discharge fluid via a first passage and a second passage to move the work tool;
an input device configured to generate a signal indicative of a desire to move the work tool via the actuator;
a pump configured to draw low-pressure fluid from one of the first and second passages and discharge fluid at an elevated pressure into the other of the first and second passages based on the signal from the input device;
a charge circuit fluidly connected to the first and second passages;
a force modulation control valve configured to selectively direct fluid from either of the first and second passages to the charge circuit based on the signal from the input device; and
at least one relief valve configured to selectively direct fluid discharged from the pump to the charge circuit when the elevated pressure exceeds a variable pressure relief threshold, wherein the variable pressure relief threshold is adjustable based on the signal from the input device.
